(19) United States
(12) Patent Application Publication
(10) Pub. No.: US 2007/0076165 A1
(43) Pub. Date: Apr. 5, 2007

(54) Double clipping device

(76) Inventor: Aleesha Karley Ashlie, Matthews, NC (US)

Correspondence Address: ALEESHA K. ASHLIE;c/o LYDIA GEISHEIMER, 6017 GREY STONE DRIVE, MATTHEWS, NC, 28106, US

(21) Appl. No.: 11/243,340

(22) Filed: Oct. 3, 2005

(51) Int. Cl. G02C 5/14

(52) U.S. Cl. 351/112

(57) ABSTRACT

A double clipping device, designed to secure personal items, and which can be attached to either clothing or to solid surfaces. The device features at least two powerful spring clips pivotally attached to each other. A useful eyeglass holder can be built including a first clip designed for securing a pair of eyeglasses, preferably by holding the nosebridge section, pivotally attached, to a second clip which is suited for attaching the eyeglass holding device to a fabric garment. One or more mounting plates can also be employed to removably attach the device to solid surfaces. Each mounting plate is secured to a wall or to a car dashboard or other desired location. The double clipping device is built with a mounting plate receiving element, where the double clipping device is removably attached to each desirably located mounting plate.

### BACKGROUND

Spring loaded clips have been known and used for many interesting purposes, and one such usage which is somewhat related to this invention is a spring loaded clothes pin, used for firmly attaching wet laundry to a rope line, typically hung in the sun so that the clothes can dry after washing, and where the laundry is firmly held to the rope line, even in a strong breeze. Such clothes pins utilize two elongated elements connected by a metal coil spring. The two elongated elements of such clothes pins are typically made of wood or plastic. Eyeglass holding devices have also been used in the past such as taught in U.S. Pat. No. 5,860,191 by Sieger, U.S. Pat. No. 5,956,812 by Moennig, and U.S. Pat. No. 6,076,925 by Kraut. These devices can include a spring loaded clip, however, the clip designs are primitive and prone to slipping off of fabric, and none include a double clipping device. The eyeglasses in these prior designs are supported by simply hooking an eyeglasses ear stem through a loop and they are prone to falling out of such a design. Thus there has been a longfelt need for a secure method to attach eyeglasses and other personal effects to a user's garment, and also to attach such a useful device to hard surfaces as well.

### SUMMARY

A double clipping device, designed to secure personal items, and which can be attached to either clothing or to solid surfaces. The novel apparatus features at least two powerful spring clips pivotally attached to each other. Due to the innovative design, this clipping device can attach to all types of clothing, and also requires no pocket or shirt placket for attachment. The device also attaches to hard surfaces as well as fabrics, increasing the overall versatility. The clipping device can be adapted for holding specific items, such as to attach eyeglasses, or ID cards to a user's garment. A useful eyeglass holder can be designed, including a first clip built to dimensions suited for securing a pair of eyeglasses, pivotally attached, to a second clip which is suited for attaching the eyeglass holding apparatus to a fabric garment. The eyeglass holding clip, and the garment attachment clip are each built using a strong spring powered clip such as a coiled wire type spring. In use, the eyeglasses are attached to the double clipping device, by clipping the first clip around the nose bridge portion of the eyeglasses, where the interior dimensions of the first clip in a closed position are designed specifically to match the dimensions of common eyeglass nose bridges. The second clip can be attached to a garment using a second powerful spring clip. The first clip is designed to specifically and firmly grasp a pair of eyeglasses by the nose bridge, and the second clip is specifically designed to attach securely directly to a wide range of fabrics. The first and second clips are pivotally attached, so that when a person with eyeglasses clipped to their garment, moves or changes position, the eyeglasses portion of the clip can pivot with gravity, and remain in a center balanced position. Thus twisting stress is reduced at the fabric attachment of the second clip, and the eyeglass holder garment clip is less likely to be pulled off of the garment. A third holding element can also be employed to attach the double clipping device to solid surfaces, such as by using one or more base station mounting plate pieces. Each mounting plate piece is secured to a wall or to a car dashboard or other desired location, such as by using glue, tape or other fastener. The double clip apparatus can be built with a mounting plate receiving element, where the double clip apparatus can be attached to a mounting plate piece, either holding the eyeglasses or not. The eyeglasses, can be securely attached to a clothing garment, and then later removed from the garment and attached to a wall or vehicle dashboard. The device is designed to securely and comfortably hold eyeglasses, thereby preventing loss or damage and allows user to always know where their eyeglasses are.

### DETAILED DESCRIPTION

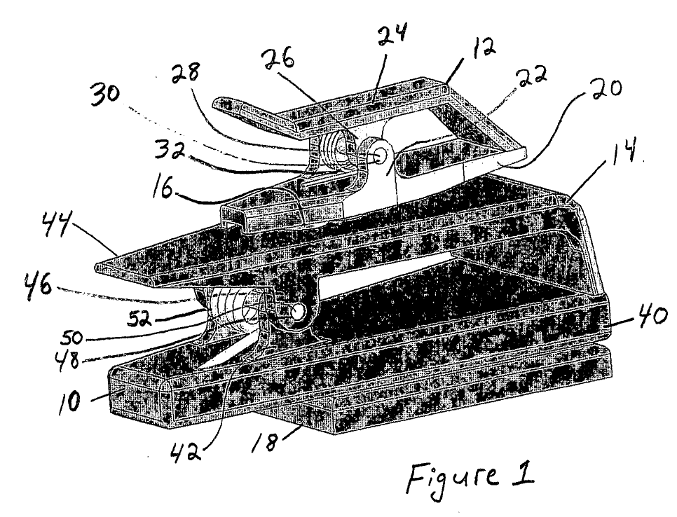

### FIG. 1

The present disclosure describes a novel clipping device with two spring loaded clips pivotally connected, designed to securely hold personal items such as eyeglasses, such that the item can be attached to either clothing or to solid surfaces. The novel apparatus features two powerful spring clips pivotally connected to each other. The clipping device can be adapted for holding specific items, such as for attaching eyeglasses, or ID cards to a user's garment. A useful eyeglass holder can be designed within the scope of this invention, including a first clip built to dimensions suited for securing a pair of eyeglasses, pivotally connected to a second clip which is suited for attaching the eyeglass holding apparatus to a fabric garment. This embodiment of the invention will serve as an example herein to demonstrate how to make and use the invention. FIG. 1 depicts such an embodiment of the clipping device 10.

The clipping device 10 as described herein in an embodiment of an eyeglasses holding device comprises two clips, a first spring loaded clip 12 which is designed as an eyeglass holding clip, and a second spring loaded clip 14 designed for attaching to a fabric garment. The first clip 12 and the second clip 14 are pivotally connected by a pivot pin 16 so that the two clips can rotate relative to each other. The clipping device 10 can further comprise a mounting plate 18 so that when such a mounting plate 18 is affixed to a solid surface, like a wall near a telephone, then a user of the device 10 can temporarily attach the clip holding their eyeglasses to the wall near the telephone for easy access.

The first spring loaded clip 12 designed for clipping onto and holding the nose bridge section of the eyeglasses, comprises a first base member 20 with an integral first base member hinge piece 22. The first spring loaded clip 12 also comprises a first movable jaw 24 with an integral first movable jaw hinge piece 26. Both the first base member hinge piece 22 and the first movable jaw hinge piece 26 have receiving holes 28 which are sized and aligned to fit a first hinge pin 30. When the base 20 and the jaw 24 are aligned, they can be movably connected with the hinge pin 30, so that the jaw 24 can move relative to the base 20, in an opening and closing motion. The first clip is provided with a first coil spring 32, to hold the jaw 24 in a firmly closed position tight against the base 20. It is important that the spring 32 used is powerful enough to keep the jaw 24 of the first clip 20 firmly closed so that the eyeglasses cannot fall out of the device and get lost or damaged. A strong coiled metal spring is preferred, as simple bent metal type clips were found to be too weak, and ineffective in retaining a pair of eyeglasses under some user circumstances. The first coil spring 32 comprises a coiled body and two ends where one end is in contact with the base member 20, and the second coil spring end is in contact with the movable jaw 24.

In a preferred embodiment, the first movable jaw 24 has a bent angle as shown in the FIG. 1, forming a wedge shaped area under the jaw 24, and the maximum height under the first movable jaw 24, between the movable jaw 24 and the first base member 20 has a distance of approximately ⅝ of and inch, to help hold the nose bridge section of a pair of eyeglasses

The second spring loaded clip 14 designed for clipping the device onto a device user's garment. The second clip 14 comprises a second base member 40 with a second integral base member hinge piece 42. The second spring loaded clip 14 also comprises a second movable jaw 44 with an integral second movable jaw hinge piece 46. Both the second base member hinge piece 42 and the second movable jaw hinge piece 46 have receiving holes 48 which are sized and aligned to fit a second hinge pin 50. When the base 40 and the jaw 44 are aligned, they can be movably connected with the hinge pin 50, so that the jaw 44 can move relative to the base 40, in an opening and closing motion. The second clip is provided with a second coil spring 52, to hold the jaw 44 in a firmly closed position tight against the base 40. It is important that the spring 52 used is powerful enough to keep the jaw 44 of the second clip 40 firmly closed so that the device with attached eyeglasses cannot detach from the user's garment. A strong coiled metal spring is preferred, as simple bent metal type clips were found to be too weak, and ineffective in retaining a pair of eyeglasses under some user circumstances. The second coil spring 52 comprises a coiled body and two ends where one end is in contact with the base member 40, and the second coil spring end is in contact with the movable jaw 44.

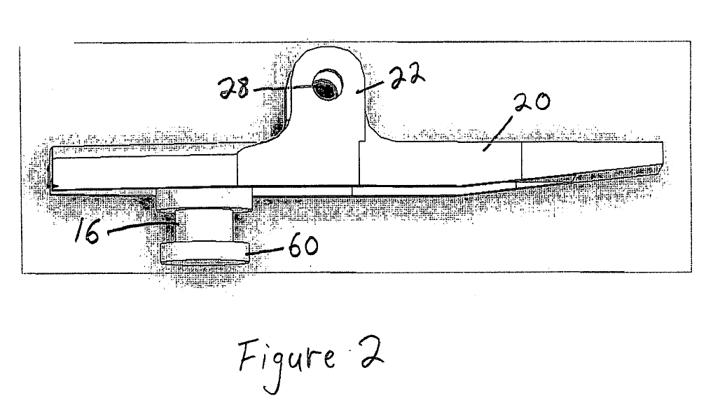

### FIG. 2

In one preferred embodiment as shown in FIG. 2 the first base member 20 can be made with a pivot pin 16 which comprises a pivot pin locking knob 60, which can be an enlarged cylindrical portion of said pivot pin 16, such that the diameter of the locking knob 60 is larger than the diameter of the pivot pin 16.

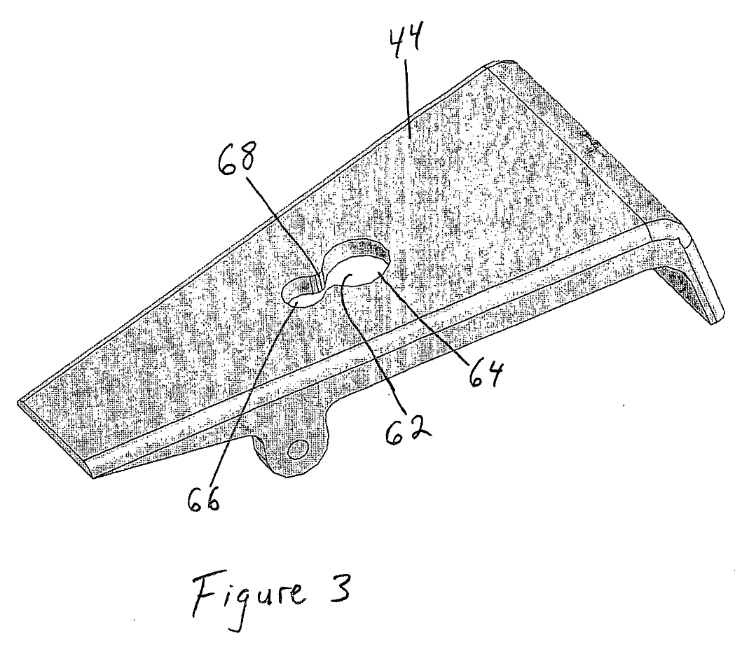

### FIG. 3

As shown in FIG. 3, the second movable jaw 44 can be made with a FIG. 8 style hole 62 which comprises a larger portion 64 and a smaller portion 66 of said FIG. 8 style hole, and a central locking portion 68 which has a cross sectional dimension smaller than the diameter of the smaller hole portion 66. The larger hole portion 64 is sized slightly larger than the pivot pin locking knob 60 such that the locking knob 60 can be inserted through the larger hole portion 64. the smaller hole portion 66 is sized slightly larger than the diameter of the pivot pin 16, such that the pin can rotate when inserted into the smaller hole portion 64. The central locking portion of the FIG. 8 style hole has a cross sectional dimension of approximately the same size as the diameter of said pivot pin 16, or slightly smaller. Thus this embodiment allows the first spring loaded clip 12 to be pivotally attached to the second spring loaded clip 14 in the following manner. The locking knob 60 of the first base member 20, is inserted into the larger hole portion 64 of the second movable jaw 44. The first base member 20 is then snapped onto the second movable jaw 44 such that the pivot pin 16 is pushed forcibly past the central locking hole portion 68 of the second movable jaw 44, and the pivot pin ends up pivotally locked into the smaller hole portion 66 of the second movable jaw.

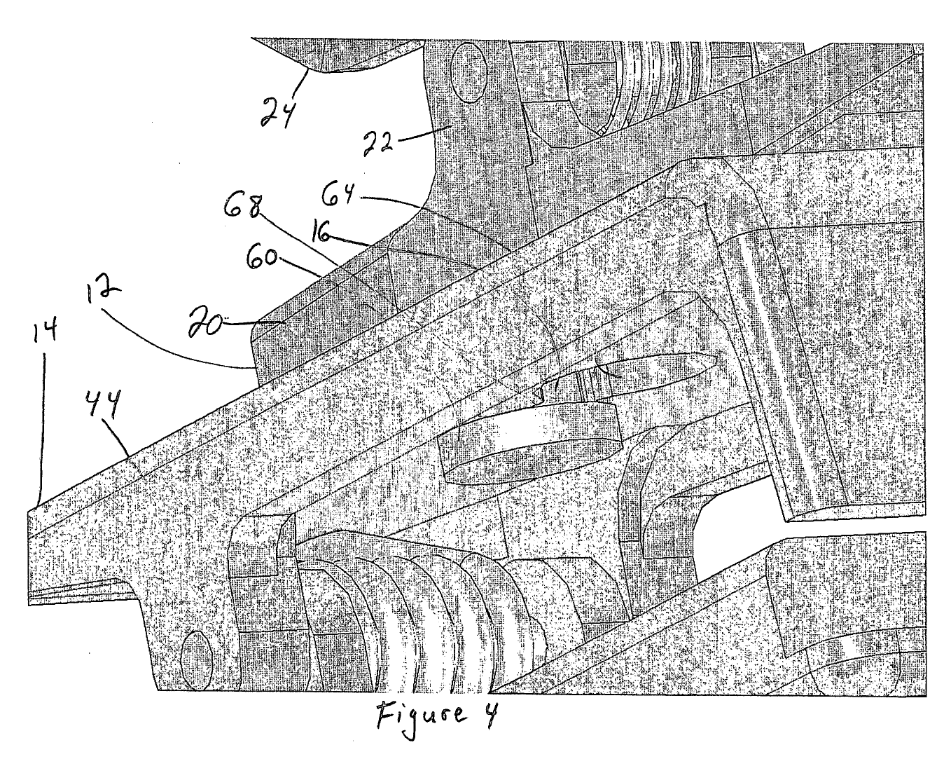

### FIG. 4

FIG. 4 shows an expanded view of the first spring loaded clip 12 thusly pivotally attached to the second spring loaded clip 14 as described in the above mentioned preferred embodiment. Obviously, other means can be used to pivotally attach the two clips 12 and 14, as are known or can be developed by those skilled in the arts, to enable two spring loaded clips such as 12 and 14 to be pivotally attached.

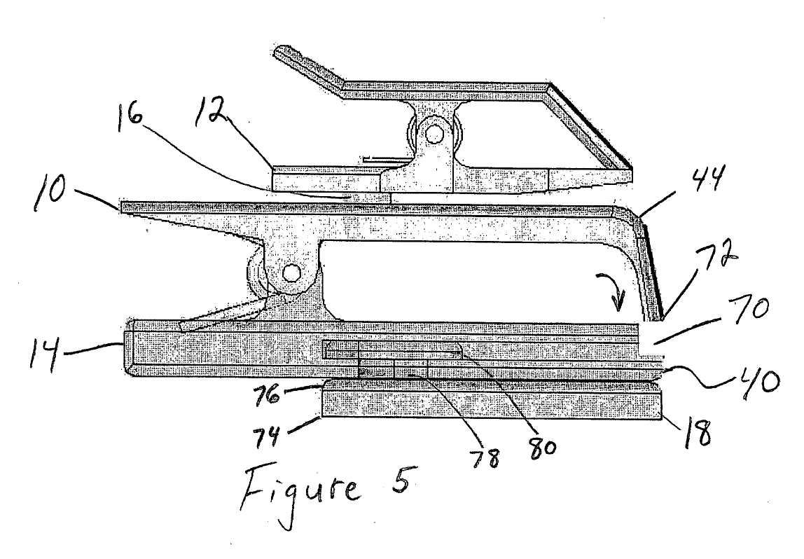

### FIG. 5

To further enhance the overall utility of the inventive double clipping device 10, further inventive features may also be employed. As shown in FIG. 5 the second base member 42 of the second spring loaded clip 14 can further employ a notched out region 70 of said second base member 42, in the proximity of the region where the outermost tip 72 of the second movable jaw 44 firmly closes up against the second base member 42 in a spring loaded fashion. This additional notched region 70 provides the second clip 14 with a more powerful grasp for firmly attaching the device 10 to a user's garments regardless of the type of fabric of the garment. Without the employment of said notched out region 70, a spring loaded clip 10 would not have the same holding ability as with this feature, and the device would be more likely to slip off of certain types of garment fabrics, especially when the device 10 is used to attach to sheer fabrics such as silk.

Yet another additional inventive feature of the present inventive double clipping device, is the employment of mounting plate 18, also shown in FIG. 5. Such a mounting plate 18 can be removably attached to the clipping device 10 in a variety of ways. One such preferred embodiment of attaching a mounting plate 18 to a clipping device 10 is depicted in FIG. 5. In this embodiment a mounting plate 18 is designed as an elongated member, of approximately the same width as the second base member 42 of the double clipping device 10, although the width and dimensions of the mounting plate 18 are not critical, it was found to be esthetically pleasing and physically functional within these approximate relative dimensions. Such a mounting plate 18 can be described as having a bottom portion 74 and a top portion 76. The bottom portion 74 can be made to attach firmly to a solid surface such as a wall or a vehicle dash board. Such attachment can be permanent or can be removably attached. A mounting plate bottom portion 74 can be attached to a solid surface in a any number of means such as with nails screws, double sided tape, hook and loop materials such as Velcro, or with adhesives. More than one mounting plates 18 can be used so that for example, one mounting plate 18 can be attached to a wall near a telephone and a second mounting plate 18 can be left attached to a vehicle dash board. Thus for example, a double clipping device 10 such as designed for holding eyeglasses can be connected overnight to a first mounting plate 18 which is attached to a wall near a telephone, then the device user can remove the device 10 from this wall mounted mounting plate 18 and attach the device with eyeglasses to their garment as they move through the house. Later if the user of said device 10 goes to their vehicle, the double clipping device 10 can be connected to a mounting plate 18 which is attached to the vehicle dash board. In this manner, the utility of such an inventive device can be shown, so that the user of the device 10 can always know where their eyeglasses are, and the eyeglasses can be safely placed for easy access storage as the user moves throughout their daily activities.

Referring back to FIG. 5, a phantom view shows one embodiment of how such a mounting plate 18 can be removably attached to a double clipping device 10. In this depicted embodiment, the mounting plate top side 76 comprises a tubular mounting plate connection pin 78 and a mounting plate connection pin knob 80. The knob 80 as shown, is of a larger diameter size than the tubular connection pin 78.

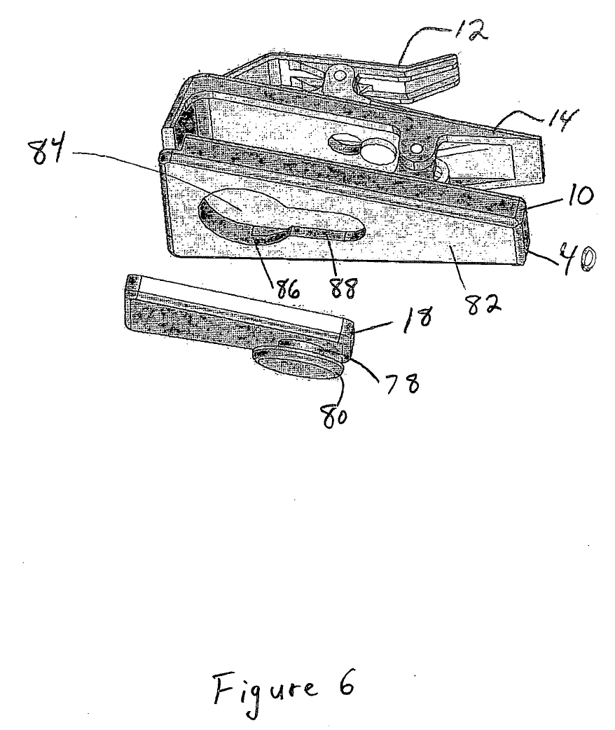

### FIG. 6

FIG. 6 depicts a double clipping device 10 and a mounting plate 18 which are illustrative of this preferred embodiment, where these two elements are detached. The bottom section 82 of the second base member 40 in this embodiment, has a recessed keyhole shaped receiving slot 84, with a large rounded entry portion 86 and a narrow knob holding portion 88. The rounded entry portion 86 is sized slightly larger in diameter than the connection pin knob 80, so that a connection pin knob 80 can be fit into the keyhole shaped slot 84. The double clipping device 10 is then slid relative to the mounting plate 18 such that the connection pin knob 80 fits up into the narrow knob holding portion 88 of said keyhole shaped slot 84. The width of the open portion of the narrow knob holding portion 88 is slightly larger than the diameter of the connection pin 78, and more narrow than the diameter of the connection pin knob 80. Thus the clipping device 10 can be quickly, easily and removably attached to a mounting plate 18. Obviously, other configurations of design can be similarly employed to removably attach a clipping device 10 to a mounting plate 18, where the utility is the same and the device still would be construed to fall within the scope of this invention.

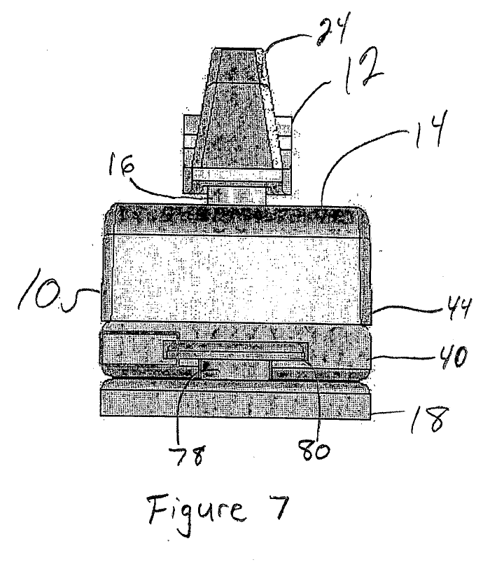

### FIG. 7

FIG. 7 shows a front view of the device 10, where a mounting plate 18 is attached to the second base member 40 employing the above describe preferred embodiment with an tubular connection pin 78 and a connection pin knob 80.

Each of the components of the present invention can be made of molded plastic, wood or metal, as appropriate, except for the first spring 32 and the second spring 52, which are preferably metal, such as made of spring quality steel, in a coiled fashion, with two elongated straight ends, one straight end at each end of said coil. Furthermore, many types of designs, ornaments and embellishments can also be added.

What is claimed is:

1. A device for holding eyeglasses, where said device comprises a first spring powered clip pivotally attached to a second spring powered clip, where
the first clip comprises a base member with a base member hinge piece,
a movable jaw with a movable jaw hinge piece,
a hinge pin attaching the two hinge pieces, so that the jaw is rotatably attached to the base member,
a coil spring which is wrapped around the hinge pin, such that the ends of the spring are in forceful contact with the base member and the jaw, holding the jaw firmly closed relative to the base member,
and where the second clip also comprises a base member with a base member hinge piece,
a movable jaw with a movable jaw hinge piece,
a hinge pin attaching the two hinge pieces, so that the jaw is rotatably attached to the base member,
a coil spring which is wrapped around the hinge pin, such that the ends of the spring are in forceful contact with the base member and the jaw, holding the jaw firmly closed relative to the base member

2. A device for holding eyeglasses as in claim 1, where the base member of the first clip has a recessed notch such that the tip of the first clip jaw fits snugly into the notch when the clip is in a closed position.

3. A device for holding eyeglasses as in claim 1, where the jaw of the second clip has a bent angle such that the distance between the second base member and the second jaw becomes gradually smaller towards the tip of the second jaw.

4. A device for holding eyeglasses as in claim 1, where the maximum distance between the jaw of the second clip and the base member of the second clip is approximately ⅝ of an inch when the second jaw is in a closed position.

5. A device for holding eyeglasses as in claim 1, where the base member of the first clip is removably attached to a mounting plate.

6. A device for holding eyeglasses as in claim 5, where the base member of the first clip is removably attached to a mounting plate, where said mounting plate has a keyhole shaped receiving slot.

7. Two spring powered clips pivotably attached to each other where at least one of the clips is powered by a coiled spring.

8. A device as in claim 7 where both clips are powered by a coiled spring.
